(19) United States
(12) Patent Application Publication
(10) Pub. No.: US 2026/0328324 A1
(43) Pub. Date: Oct. 22, 2026

(54) ANTI-LOOSENING LIQUID-COOLING CONNECTOR

(71) Applicant: JPC CONNECTIVITY INC., New Taipei City (TW)

(72) Inventors: Yung-Chih FAN, New Taipei City (TW); Chun-Chia CHEN, New Taipei City (TW); Sheng-Ho YANG, New Taipei City (TW); Huang-Cheng LU, New Taipei City (TW)

(21) Appl. No.: 19/630,586

(22) Filed: Mar. 27, 2026

(30) Foreign Application Priority Data
Apr. 22, 2025 (TW) 114115141

(51) Int. Cl. F16L 37/44

(52) U.S. Cl. CPC F16L 37/44

(57) ABSTRACT

An anti-loosening liquid-cooling connector includes a plug body, an unlock kit, a backstop kit, a first locking element, and a second locking element. The plug body has a cavity extending to a front end thereof to form a plug opening, and a first actuating hole and a second actuating hole are formed around the plug body relative to the plug opening. The unlock kit elastically sheathes the plug body. The backstop kit elastically blocks between the plug opening and the cavity. The first locking element is movably installed in the first actuating hole; the second locking element is movably installed in the second actuating hole and has a positioning part and a retaining part radially movable in the second actuating hole. The unlock kit elastically abuts against the first locking element to radially displace and abuts against the positioning part to radially displace the second locking element.

### BACKGROUND OF THE DISCLOSURE

### Technical Field

The present disclosure relates to the field of connectors, particularly relates to an anti-loosening liquid-cooling connector.

### Description of Related Art

In related-art cooling systems that utilize a liquid to circulate in the systems for heat dissipation, the pipes used for circulating the liquid often need to be connected by means quick connectors such as quick couplings, quick fittings, or the like.

However, the related-art quick connectors generally use a ball-shaped fixing element rolled between a male-threaded end and a female-threaded end of the pipes in order to connect the pipes, thereby achieving the effect of preventing the connected male and female threaded ends from being detached easily; or other locking elements having a more complex structural design for enhancing the fixing effect. Although the aforementioned connectors or locking elements have the effect of preventing the pipes or connectors from being accidentally separated due to external forces, the preventing effect is still limited, so that when the external force such as a pulling force exceeds the upper limit, separation or liquid leakage will still occur.

In view of the deficiencies of the related art, the present discloser conducted researches based on the existing technologies and the application of theories, and finally proposed a reasonable and feasible design in accordance with the present disclosure to overcome the deficiencies of the related art.

### SUMMARY OF THE DISCLOSURE

The primary objective of the present disclosure is to provide an anti-loosening liquid-cooling connector, which further adds other locking elements with radial restriction on the basis of having a clamping or locking element to provide a greater tensile force, so as to prevent the connector from being forcibly separated, thereby improving the stability and reliability of the connector.

To achieve the aforementioned objective, the present disclosure provides an anti-loosening liquid-cooling connector including: a plug body, an unlock kit, a backstop kit, at least one first locking element, and at least one second locking element. The plug body has a cavity, the cavity extends towards the front end of the plug body and has a plug opening, and the plug body further includes at least one first actuating hole and at least one second actuating hole surrounding the periphery of the plug opening. The unlock kit is elastically and movably sleeved on the plug body, the backstop kit is installed in the cavity and blocked between the plug opening and the cavity by an elastic force, the first locking element is movably installed to the at least one first actuating hole, the second locking element is movably installed to the second actuating hole, and has a positioning part located outside the second actuating hole and protruding downwardly and a retaining part radially displacing in the second actuating hole. Wherein, the unlock kit pushes the first locking element in the first actuating hole with an elastic force to make an axial displacement, and presses the positioning part to make the second locking element move radially in the second actuating hole, so that the unlock kit generates a radial acting force on the second locking element and restrict the second locking element to be located in the second actuating hole.

### BRIEF DESCRIPTION OF THE DRAWINGS

FIG. 1 is a perspective view showing the disassembled parts of an anti-loosening liquid-cooling connector of the present disclosure;

FIG. 2 is a partially exploded view of an anti-loosening liquid-cooling connector of the present disclosure;

FIG. 3A is an exploded view of a plug body of the present disclosure plug body;

FIG. 3B is a perspective view of a first locking element of the present disclosure;

FIG. 3C is a perspective view of a first second element of the present disclosure;

FIG. 4 is an exploded view of a docking connector of the present disclosure;

FIG. 5 is a cross-sectional view showing the docking status of a connector of the present disclosure;

FIG. 6 is a first cross-sectional view showing the plugging operation of the present disclosure;

FIG. 7 is a second cross-sectional view showing the plugging operation of the present disclosure;

FIG. 8 is a third cross-sectional view showing the plugging operation of the present disclosure;

FIG. 8A is a blowup view of Section A of FIG. 8;

FIG. 8B is a blowup view of Section B of FIG. 8;.

FIG. 9 is a cross-sectional view showing the plugging/unplugging operation of the present disclosure;

FIG. 10 is a partially exploded view of the present disclosure adopting a spherical first locking element; and

FIG. 11 is a cross-sectional view showing the docking status of a connector of the present disclosure adopting a spherical first locking element.

### DETAILED DESCRIPTION

The detailed description and technical contents of the present disclosure are illustrated with reference to the accompanying drawings, which are intended for the illustrative purposes only, but not intended for limiting the disclosure.

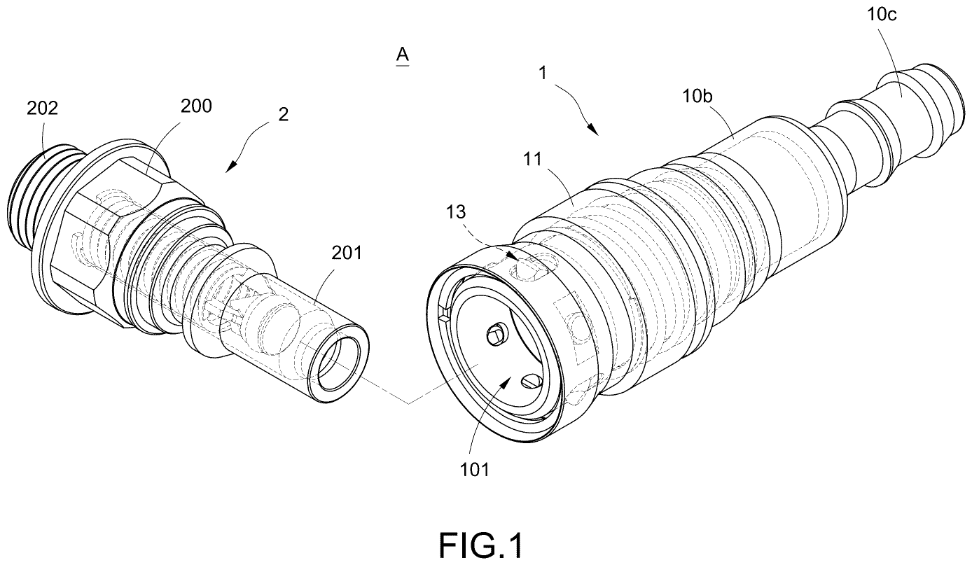

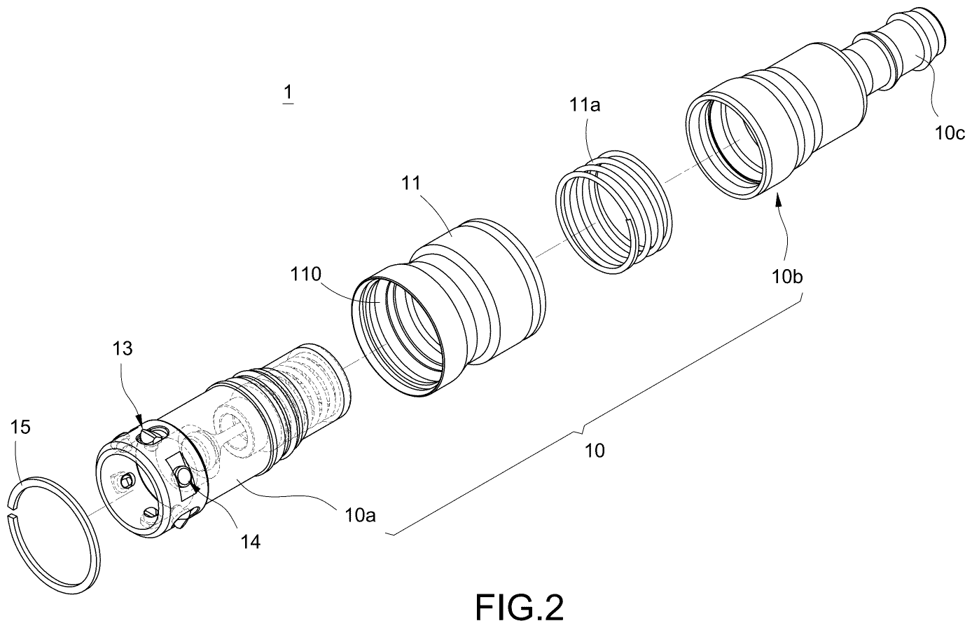

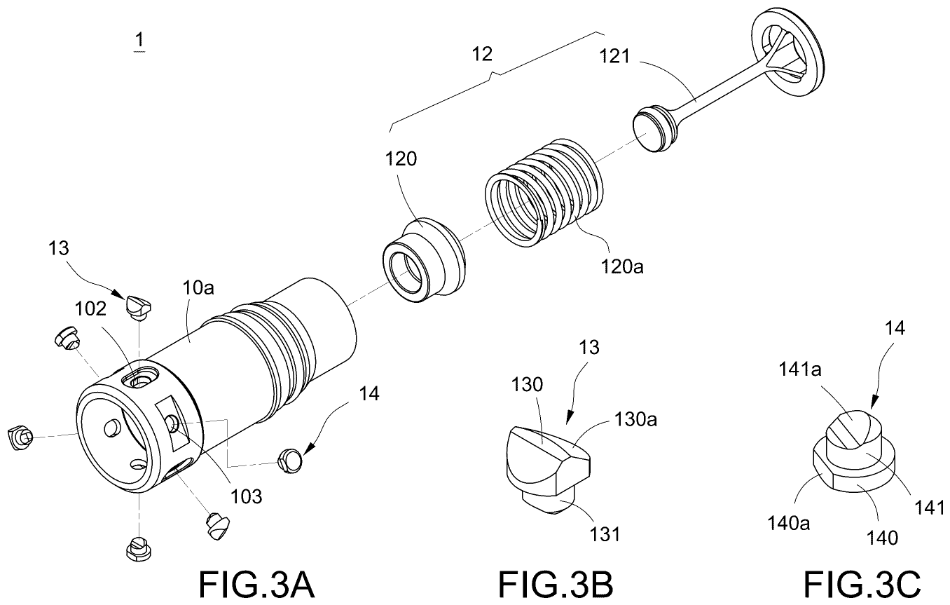

With reference to FIG. 1 for the exploded view of a connector of the present disclosure, the present disclosure discloses an anti-loosening liquid-cooling connector 1 which is connected with a docking connector 2 to form a connecting device A, so as to achieve the purpose of connecting a pipeline (not shown in the figures) of a cooling system for liquid circulation. In FIGS. 2 and 3A, the anti-loosening liquid-cooling connector 1 includes a plug body 10, an unlock kit 11, a backstop kit 12, at least one first locking element 13, and at least one second locking element 14.

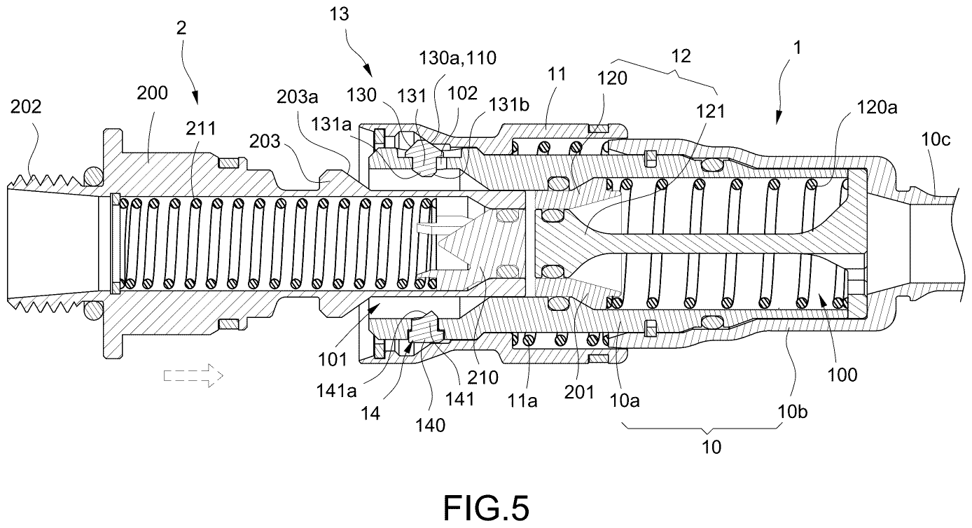

As shown in FIGS. 2 and 3A, the plug body 10 is provided for elastically and movably installing unlock kit 11 to the outside of the plug body 10, and provided for configuring the backstop kit 12 into the plug body 10. In an embodiment of the present disclosure, as shown in FIG. 5, the plug body 10 includes a main body 10a and a pipe joint 10b, the main body 10a has a cavity 100 provided for installing the backstop kit 12 therein, the cavity 100 extends towards and communicates with the front end of the main body 10a to form a plug opening 101, the pipe joint 10b is sleeved on the rear end of the main body 10 to close the cavity 100, and the rear end of the pipe joint 10b has a pipe joint 10c which is provided for the anti-loosening liquid-cooling connector 1 to be installed to a pipeline (not shown in the figures) of a cooling system, which is provided for circulating a liquid.

As shown in FIG. 2, the unlock kit 11 is movably sleeved on the plug body 10, and an elastic element 11a abuts against the plug body 10 and provides an elastic force towards the front end of the main body 10a. In a specific embodiment, the moving stroke of the unlock kit 11 on the plug body 10 does not exceed the end of the plug body 10, or the moving distance is not greater than the length of the plug body 10. In FIG. 3A, the backstop kit 12 includes a piston 120, and a backstop 121 is arranged on the piston 120 for blocking the piston 120. The piston 120 is pushed by an elastic force of an elastic element 120a and blocks together with the backstop 121 between the plug opening 101 and the cavity 100 (as shown in FIG. 5), such that when the liquid of the cooling system enters from the pipe joint 10c into the plug body 10, the liquid is blocked by the backstop kit 12 to prevent the liquid from overflowing from the plug opening 101.

In FIGS. 3A and 3B, the first locking element 13 is movably disposed on the main body 10a of the plug body 10 and located opposite to the plug opening 101. In a specific embodiment, the main body 10a is provided with at least one first actuating hole 102 at the periphery relative to the plug opening 101, and the first locking element 13 is movably disposed in the first actuating hole 102. When the quantity of first locking elements 13 is plural, the quantity of first actuating holes 102 is also set to be plural with the corresponding quantity. In the embodiment as shown in FIG. 5, the first locking element 13 includes a limit part 130 located outside the first actuating hole 102, and a latching part 131 protruding downward from the limit part 130 and displaceable in the first actuating hole 102 in the axial direction (i.e., in the plugging or plugging direction, with the plugging direction being the axial inner side and the plugging and pulling direction being the axial outer side). The latching part 131 is smaller than the limit part 130 in radial dimension relative to the first actuating hole 102, so that when the first locking element 13 is disposed in the first actuating hole 102, the latching part 131 is located in the first actuating hole 102, thereby will not fall into the plug opening 101.

In FIGS. 3A and 3C, the second locking element 14 is also movably disposed on the main body 10a of the plug body 10, and arranged in a circumferential direction with the first locking element 13 relative to the plug opening 101, and they are arranged on the same circumference or in a staggered manner. In a specific embodiment, the main body 10a is provided with at least one second actuating hole 103 at the periphery relative to the plug opening 101, the second actuating hole 103 and the first actuating hole 102 are arranged in a circumferential direction on the main body 10a, and the second locking element 14 is movably arranged in the second actuating hole 103. When the quantity of second locking elements 14 is plural, the quantity of second actuating holes 103 is also set to be plural with a corresponding quantity. In this embodiment as shown in FIG. 5, the second locking element 14 includes a positioning part 140 located outside the second actuating hole 103, and a retaining part 141 protruding downward from the positioning part 140 and capable of radial displacement (i.e., perpendicular to the aforementioned plugging or unplugging direction) in the second actuating hole 103. The retaining part 141 is smaller than the positioning part 140 in radial dimension relative to the second actuating hole 103, so that when the second locking element 14 is disposed in the second actuating hole 103, the retaining part 141 is located in the second actuating hole 103, thereby will not fall into the plug opening 101. At the same time, a side of the positioning part 140 of the second locking element 14 has a cut surface 140a, so that the positioning part 140 is embeddable or partially embeddable under the outer surface of the main body 10a, thereby limiting the rotation between the second locking element 14 and the main body 10a; of course, other structural designs may also be used to prevent the rotation, as long as the positioning part 140 is maintained in the second actuating hole 103 to perform the aforementioned radial displacement.

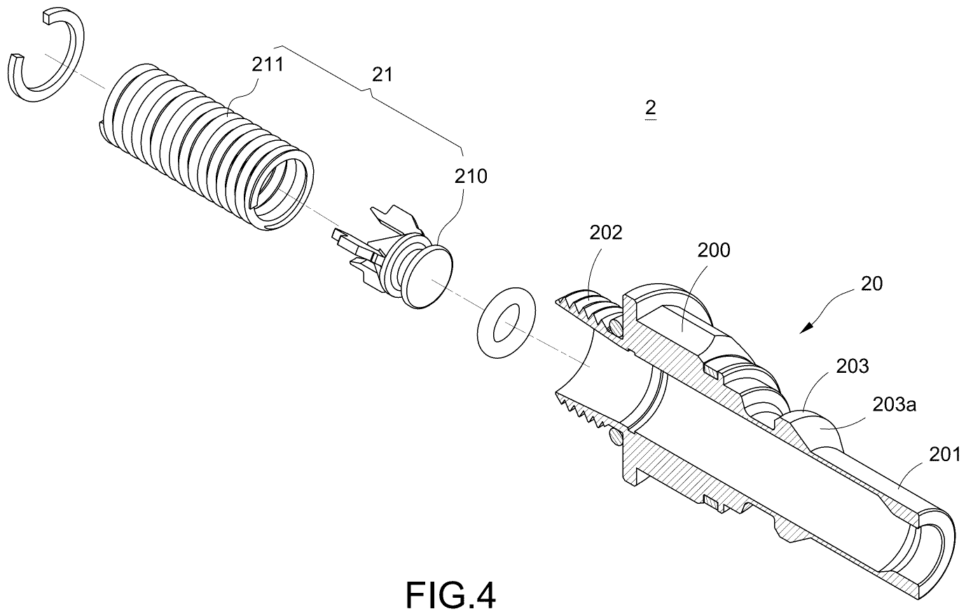

As shown in FIG. 4, the docking connector 2 is provided to be inserted into the plug opening 101 of the anti-loosening liquid-cooling connector 1, thereby pushing the piston 120 in the plug body 10 away from the backstop 121, and connecting the plug opening 101 with the cavity 100 to allow the liquid to flow. The docking connector 2 includes a docking body 20 and a sealing kit 21 disposed in the docking body 20; wherein the docking body 20 includes a base 200, a docking part 201 extending axially forward from the base 200, and a pipe joint 202 protruding backward on the base 200, so that the docking connector 2 is installable on a pipeline (not shown in the figures) of a cooling system for liquid circulation, and connected with the anti-loosening liquid-cooling connector 1 to connect the liquid circuit. The sealing kit 21 is disposed in the docking part 201 and includes a pushing member 210 and an elastic element 211 for pushing the pushing member 210 forward to seal the docking part 201, so that the docking connector 2 is sealed when not in contact with the anti-loosening liquid-cooling connector 1. When the liquid-cooling connector 1 is plugged, it also prevents the liquid in the connected pipeline (not shown in the figures) from flowing out.

Therefore, the anti-loosening liquid-cooling connector of the present disclosure is obtained by means of the aforementioned structure.

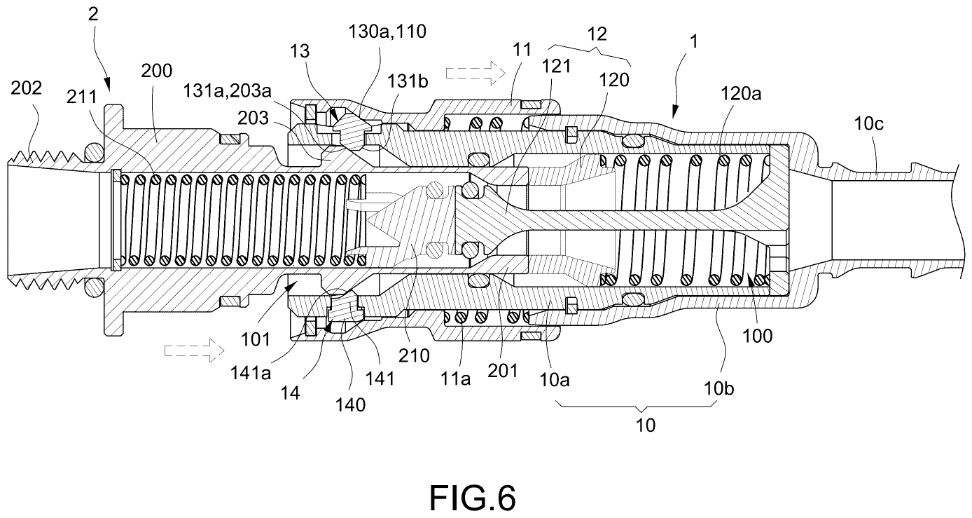

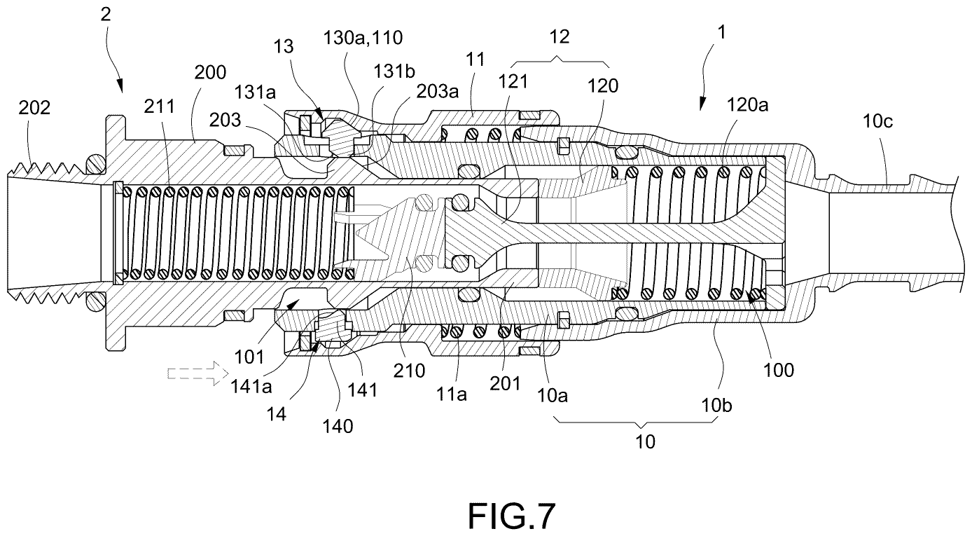

As shown in FIG. 5, when the anti-loosening liquid-cooling connector 1 is to be plugged into the docking connector 2, the docking connector 2 is inserted into the plug opening 101 of the anti-loosening liquid-cooling connector 1 by its docking part 201, so that the plugging action triggers the backstop kit 12 in the anti-loosening liquid-cooling connector 1 to operate, thereby connecting the two to allow liquid to pass through. In the embodiment of the present disclosure, the piston 120 of the anti-loosening liquid-cooling connector 1 is pushed backward by the docking part 201 of the docking connector 2; as shown in FIG. 6, when the piston 120 moves backward and disconnects from the backstop 121, the backstop 121 also extends into the docking part 201 of the docking connector 2 to push the pushing member 210 of the sealing kit 21 backward, thereby allowing the liquid in the anti-loosening liquid-cooling connector 1 and the docking connector 2 to flow, as shown in FIG. 7.

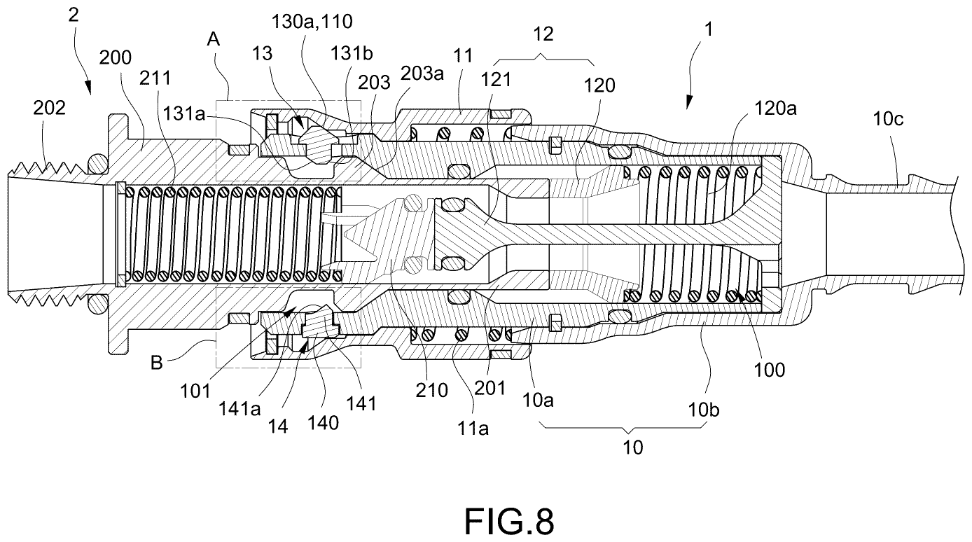

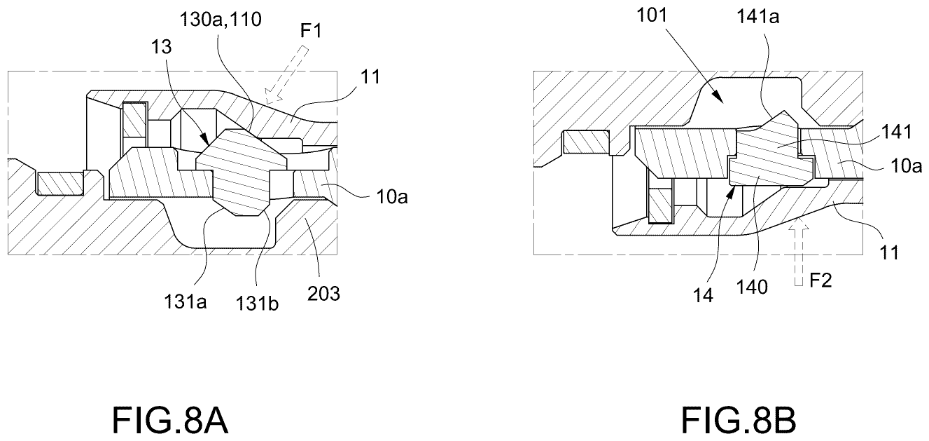

With reference to FIGS. 6 to 8 for locking the anti-loosening liquid-cooling connector 1 and the docking connector 2 after they are plugged and maintained in the plugged state, a pushing part 203 is provided on the outer ring of the docking part 201 of the docking connector 2, and the pushing part 203 has an inclined pushing surface 203a configured towards the docking direction towards the docking. As shown in FIG. 6, when the anti-loosening liquid-cooling connector 1 and the docking connector 2 are about to be connected to each other, the pushing part 203 pushes the first locking element 13 of the anti-loosening liquid-cooling connector 1. In this embodiment, the first locking element 13 has an actuating surface 131a on its latching part 131 and protrudes into the plug opening 101 through the first actuating hole 102, and a latching surface 131b opposite to the actuating surface 131a, the actuating surface 131a is oriented toward the outside of the plug opening 101, and the latching surface 131b is oriented toward the inside of the plug opening 101, and the pushing part 203 of the docking connector 2 is pushed toward the actuating surface 131a by its pushing surface 203a, so that the first locking element 13 slides radially outward on the pushing surface 203a by its actuating surface 131a, and then passes over the pushing part 203 to allow the docking part 201 to be inserted into the plug body 10, and the first locking element 13 is turned from its latching surface 131b to abut against the backside of pushing part 203. At the same time, the unlock kit 11 has an elastic force acting toward the front end of the plug body 10 to push the first locking element 13 forward and prevent it from retreating to unlock. Furthermore, the first locking element 13 is provided with an abutting surface 130a on the limit part 130, and the unlock kit 11 is provided with a ring-shaped backstop surface 110 to surround the inner surface of the unlock kit 11 and to cooperate with and abut against the abutting surface 130a, and to push the first locking element 13 to move axially in the first actuating hole 102 by the elastic force. As shown in FIG. 8A, both of the abutting surface 130a and the backstop surface 110 are oblique surfaces that act on each other, so that the backstop surface 110 generates an oblique acting force F1 on the abutting surface 130a to prevent the first locking element 13 from retreating in the reverse direction to unlock.

Based on the above, the second locking element 14 is also pushed by the pushing part 203 of the docking connector 2 to slide radially outward, so as to pass over the pushing part 203. As a result, the retaining part 141 of the second locking element 14 abuts against the backside of the pushing part 203, and the unlock kit 11 presses against the positioning part 140, so that the second locking element 14 is displaced radially in the second actuating hole 103. As shown in FIG. 8B, the unlock kit 11 applies a radial acting force F2 to the positioning part 140 of the second locking element 14 to ensure that the second locking element 14 is confined in the second actuating hole 103, so as to stably and reliably prevent the pushing part 203 from withdrawing in the reverse direction. Furthermore, the second locking element 14 is provided with a retaining surface 141a on the retaining part 141 to abut against the backside of the pushing part 203 to prevent the reverse exit and forced unlocking.

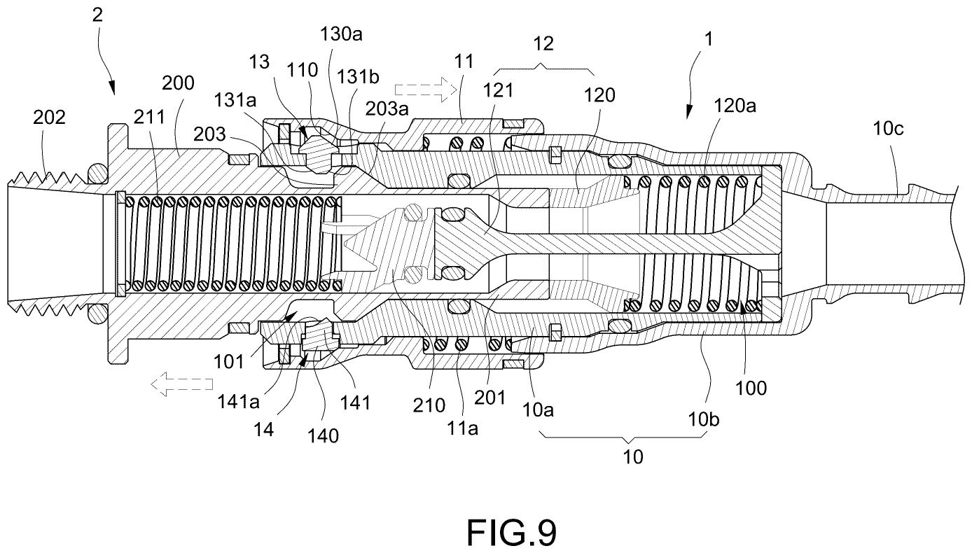

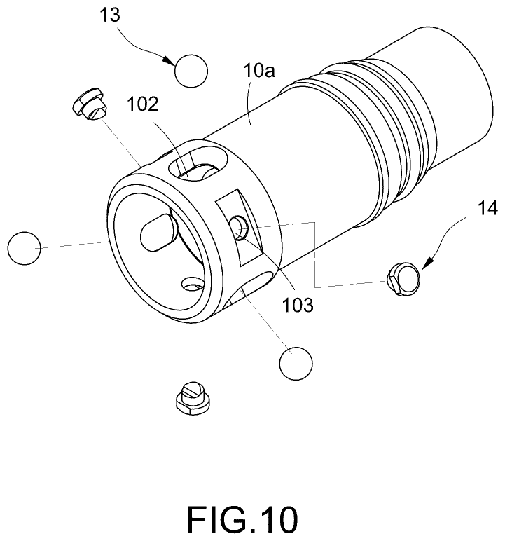

On the contrary, as shown in FIG. 9, when it is necessary to disconnect the anti-loosening liquid-cooling connector 1 and the docking connector 2, the user only needs to push the unlock kit 11 backwards, so that the backstop surface 110 of the unlock kit 11 is away from the abutting surface 130a of the first locking element 13 and the unlock kit 11 does not press against the positioning part 140 of the second locking element 14, and the docking connector 2 is disconnected from the anti-loosening liquid-cooling connector 1 quickly, so as to achieve the purpose of quick connection and disconnection.

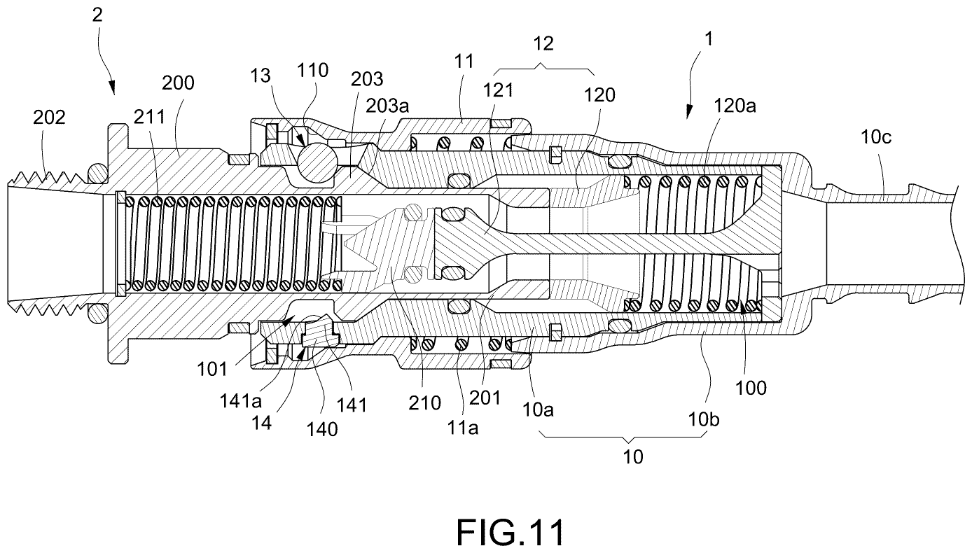

In addition, as shown in FIGS. 10 and 11, the first locking element 13 is a sphere. The spherical first locking element 13 is movably placed in the first actuating hole 102, so that a part of the sphere passes through the first actuating hole 102 and actuates with the pushing part 203 of the docking part 201 of the docking connector 2, so as to achieve the aforementioned clamping or locking effect. At the same time, the sphere rolling in the first actuating hole 102 is also conducive to the quick plugging or unplugging of the connecting device A.

Therefore, the anti-loosening liquid-cooling connector of the present disclosure is provided with a second locking element 14 in addition to the first locking element 13, and the unlock kit 11 generates the radial acting force F2 on the positioning part 140 of the second locking element 14. Since the radial acting force F2 is perpendicular to the withdrawing direction of the connector, a greater tensile force is provided to prevent the connector from being forcibly separated, thereby improving the stability and reliability during docking, reducing the risk of loosening due to vibration or external force, reducing the wear or abrasion under long-term use of this dual design, and extending the product life.

However, the embodiments above are only feasible preferred embodiments of the present disclosure, and are not intended to limit the scope of the present disclosure. Therefore, it is to be understood that all variations of equivalent techniques falling within the spirit and scope of the appended claims should be similarly included in the scope of the present disclosure.

What is claimed is:

1. An anti-loosening liquid-cooling connector, comprising:
a plug body, comprising a cavity and a plug opening, the cavity located therein, the plug opening defined at one end thereof, the plug opening extending towards another end thereof and communicating with the cavity, and the plug opening surrounded by at least one first actuating hole and at least one second actuating hole;
an unlock kit, elastically and movably sheathing the plug body;
a backstop kit, elastically and movably installed between the plug opening and the cavity;
at least one first locking element, movably installed to the at least one first actuating hole; and
at least one second locking element, movably installed to the at least one second actuating hole, comprising a positioning part and a retaining part, the positioning part located outside the second actuating hole, and the retaining part protruding from the positioning part to the second actuating hole;
wherein, the unlock kit pushes the at least one first locking element with elastic force to axially move in the first actuating hole, and the unlock kit presses against the positioning part to make the at least one second locking element move radially in the second actuating hole, so that the unlock kit applies a radial acting force to the at least one second locking element to restrict the at least one second locking element to be located in the second actuating hole.

2. The anti-loosening liquid-cooling connector according to claim 1, wherein the plug body comprises a main body and a pipe joint, the cavity is located in the main body, the plug opening is located at one end of the main body, and the pipe joint sheathes another end of the plug opening opposite to the main body.

3. The anti-loosening liquid-cooling connector according to claim 1, wherein the unlock kit comprises a backstop surface disposed inside, and when the unlock kit pushes the first locking element with elastic force, the backstop surface abuts against the first locking element.

4. The anti-loosening liquid-cooling connector according to claim 3, wherein the backstop surface is ring-shaped and surrounds inner surface of the unlock kit.

5. The anti-loosening liquid-cooling connector according to claim 1, wherein the backstop kit comprises a piston and a backstop disposed on the piston for stopping the piston, and the piston pushes with elastic force and blocks between the plug opening and the cavity together with the backstop collectively.

6. The anti-loosening liquid-cooling connector according to claim 1, wherein a quantity of the at least one first locking element corresponds to a quantity of the at least one first actuating hole, and a quantity of the at least one second locking element corresponds to a quantity of the at least one second actuating hole.

7. The anti-loosening liquid-cooling connector according to claim 1, wherein the at least one first locking element is a ball-shaped.

8. The anti-loosening liquid-cooling connector according to claim 1, wherein the at least one first locking element comprises a limit part located outside the at least one first actuating hole and a latching part protruding from the limit part and axially movable in the first actuating hole, and the at least one first locking element comprises an actuating surface on the latching part protruding through the at least one first actuating hole into the plug opening and a latching surface opposite to the actuating surface.

9. The anti-loosening liquid-cooling connector according to claim 1, wherein the positioning part of the at least one second locking element comprises a cut surface on the side thereof, and the cut surface allows the positioning part to be embedded in the plug body from outer surface of the plug body or partially embedded in the plug body.

10. The anti-loosening liquid-cooling connector according to claim 1, wherein the at least one second locking element comprises a retaining surface disposed recessively on the retaining part.
